(19) United States
(12) Patent Application Publication
(10) Pub. No.: US 2013/0030766 A1
(43) Pub. Date: Jan. 31, 2013

(54) CALIBRATION SYSTEM OF ELECTRONIC DEVICES

(71) Applicants: CHOON LEONG LOU, Hsinchu City (TW); VYTENIS VEITAS, Encinitas, CA (US); PETER DEHOLLAN, Carlsbad, CA (US)

(72) Inventors: CHOON LEONG LOU, Hsinchu City (TW); VYTENIS VEITAS, Encinitas, CA (US); PETER DEHOLLAN, Carlsbad, CA (US)

(73) Assignee: STAR TECHNOLOGIES INC., Hsinchu City (TW)

(21) Appl. No.: 13/241,787

(22) Filed: Sep. 23, 2011

(30) Foreign Application Priority Data
Jul. 25, 2011 (TW) 100126133

(51) Int. Cl. G06F 15/00

(52) U.S. Cl. 702/184

(57) ABSTRACT

The present invention discloses a calibration system for electronic devices comprising an electronic calibration device and an electronic device and having a space configured to connect to the electronic calibration device. The electronic calibration device has a calibration parameter storage module configured to pre-store a first standard parameter of a plurality of calibration items of the electronic device.

### BACKGROUND OF THE INVENTION

1. Field of the Invention

The current disclosure relates to a calibration system of electronic devices and, in particular, to a time sensitive calibration system of electronic devices.

2. Description of the Related Art

Electronic devices include many electronic components. After the electronic device has been used for a certain time, the electronic components need to be calibrated or replaced to ensure normal functionality of the electronic device. These electronic devices include both small electronic devices such as multi-meters and large electronic devices such as semiconductor manufacturing equipment.

Moreover, after calibration or replacement of the abnormal electronic components, the electronic devices are able to work normally which means the electronic devices can have regular productivity and continue to manufacture products with good quality to earn revenue for the company. If electronic devices do not receive any calibration after a certain time, the electronic device will function abnormally, which can lead to substandard production quality, increased costs, and even revenue and profit loss.

For small electronic device calibration, the devices can be sent back to the manufacturer for calibration and then returned to the customer via low-cost shipping. Alternatively, the latest calibration parameter data can be downloaded from the internet and the calibration work can be performed onsite.

In contrast to small electronic devices, large scale electronic devices, such as semiconductor manufacturing equipment, cannot be disassembled and sent back to the manufacturer for calibration. Moreover, large scale electronic devices have huge amounts of parameter data. Furthermore, the manufacturer needs to send technicians to the field to complete the calibration work, causing inconvenience and risk in transportation.

The conventional calibration of electronic devices is only configured for small electronic devices, but not large scale electronic devices. In order to solve the problems of the conventional calibration of electronic devices, the present invention discloses a calibration system which includes an electronic calibration device having time sensitive calibration parameters, an electronic device to be calibrated, and a space in the electronic device to be calibrated.

### SUMMARY OF THE INVENTION

The present invention discloses a calibration system and method thereof.

In accordance with one embodiment of the present disclosure, a calibration system of electronic devices comprises an electronic calibration device and an electronic device to be calibrated having a space configured to connect the electronic calibration device.

The electronic calibration device has a calibration parameter storage module configured to pre-store a first standard parameter of a plurality of calibration items of an electronic device to be calibrated.

In order to provide further understanding of the techniques, means, and effects of the current disclosure, the following detailed description and drawings are hereby presented, such that the purposes, features and aspects of the current disclosure may be thoroughly and concretely appreciated; however, the drawings are provided solely for reference and illustration, without any intention to be used for limiting the current disclosure.

### BRIEF DESCRIPTION OF THE DRAWINGS

The objectives and advantages of the present invention are illustrated with the following description and upon reference to the accompanying drawings in which:

FIG. 1 schematically illustrates one embodiment of the present invention indicating a calibration system of electronic devices;

FIG. 2 schematically illustrates one embodiment of the present invention indicating a structure of a calibration system of electronic devices;

FIG. 3 shows one embodiment of the present invention indicating a flow chart of an electronic calibration; and

FIG. 4 shows one embodiment of the present invention indicating a comparison flow chart.

### DETAILED DESCRIPTION OF THE INVENTION

The present invention discloses a calibration system and method thereof in order to calibrate semiconductor equipment onsite instead of requiring that the semiconductor equipment be sent back to the manufacturer.

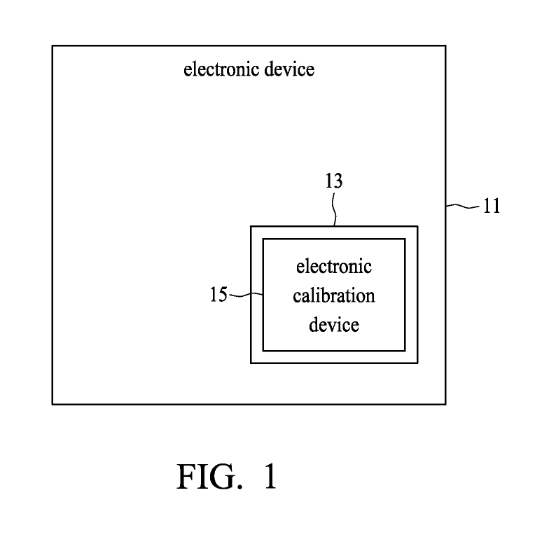

FIG. 1 schematically illustrates one embodiment of the present invention indicating a calibration system of electronic devices. In one embodiment of the present invention, electronic equipment such as semiconductor equipment has a space 13 configured to connect to an electronic calibration device 15.

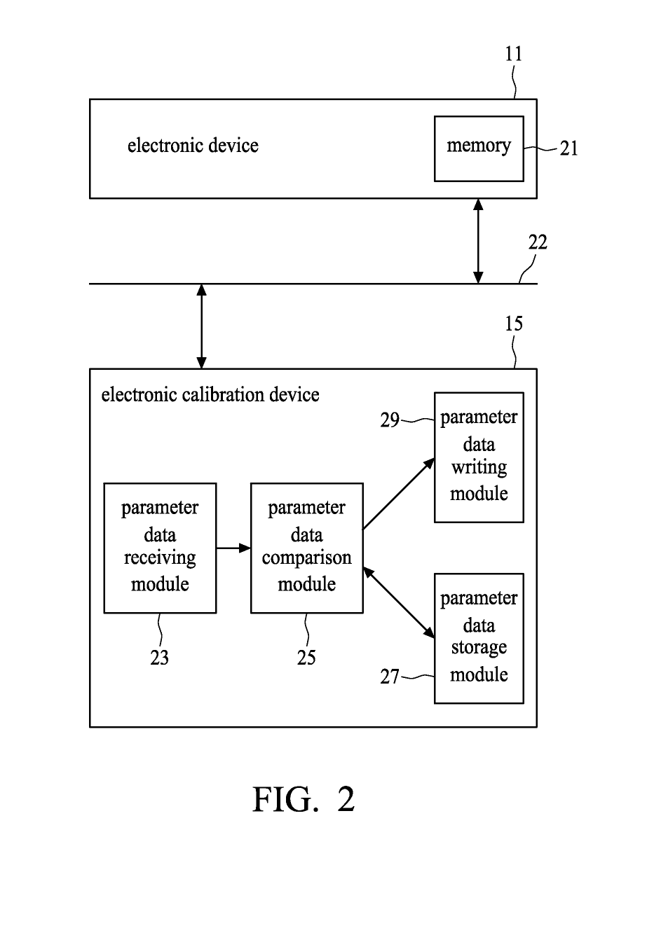

FIG. 2 schematically illustrates one embodiment of the present invention indicating a structure of a calibration system of electronic devices. In one embodiment of the present invention, the electronic calibration device 15 has a parameter data receiving module 23, a parameter data comparison module 25, a parameter data storage module 27 and a parameter data writing module 29. The parameter data storage module 27 is configured to pre-store a first standard parameter of a plurality of calibration items of an electronic device 11. The first standard parameter includes a first date which is an expiration date of the first standard parameter. In one embodiment of the present invention, the electronic device further includes a memory 21 which is configured to store a second standard parameter of the electronic device 11.

The second standard parameter further includes a second date which is a written date of the second standard parameter. Moreover, in one embodiment of the present invention, the electronic calibration device 15 connects to the electronic device 11 by a data transmitting interface 22 disposed in a space 13. The electronic calibration device 15 transmits the first standard parameter and the second standard parameter.

In one embodiment of the present invention, the parameter data receiving module 23 of the electronic calibration device 15 connects to the parameter data comparison module 25. The parameter data storage module 27 and the parameter data writing module 25 respectively connect to the parameter data comparison module 25. In one embodiment of the present invention, the parameter data receiving module 23 is configured to receive the second standard parameter of the calibration items from the electronic device 11.

In one embodiment of the present invention, the parameter data comparison module 25 is configured to compare the first date of the first standard parameter that is pre-stored in the parameter data storage module 27 with the second date of the second standard parameter of the calibration items of the electronic device. In one embodiment of the present invention, the parameter data writing module 29 is configured to write the first standard parameter and a written date into the memory 21 of the electronic device 11.

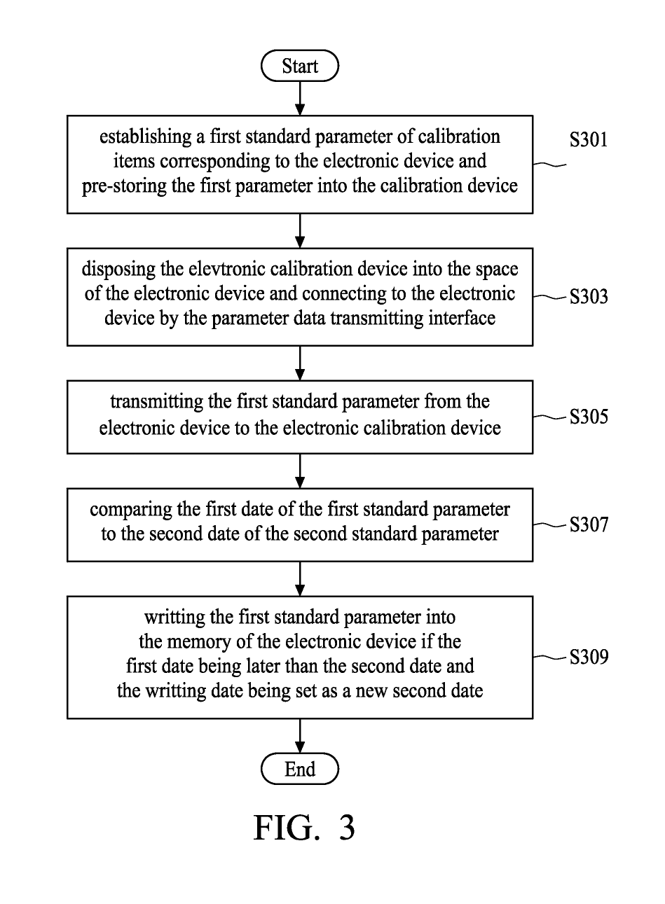

FIG. 3 shows one embodiment of the present invention indicating a flow chart of an electronic calibration. In one embodiment of the present invention, the flow chart includes the following steps: in step S301, a first standard parameter of calibration items is established corresponding to the electronic device and the first standard parameter is pre-stored in the electronic calibration device; in step S303, the electronic calibration device is disposed into the space of the electronic device and connected to the electronic device by the parameter data transmitting interface; in step S305, the first standard parameter is transmitted from the electronic device to the electronic calibration device; in step S307, the first date of the first standard parameter is compared to the second date of the second standard parameter; in step S309, the first standard parameter is written to the memory of the electronic device if the first date is later than the second date and the writing date is set as the new second date.

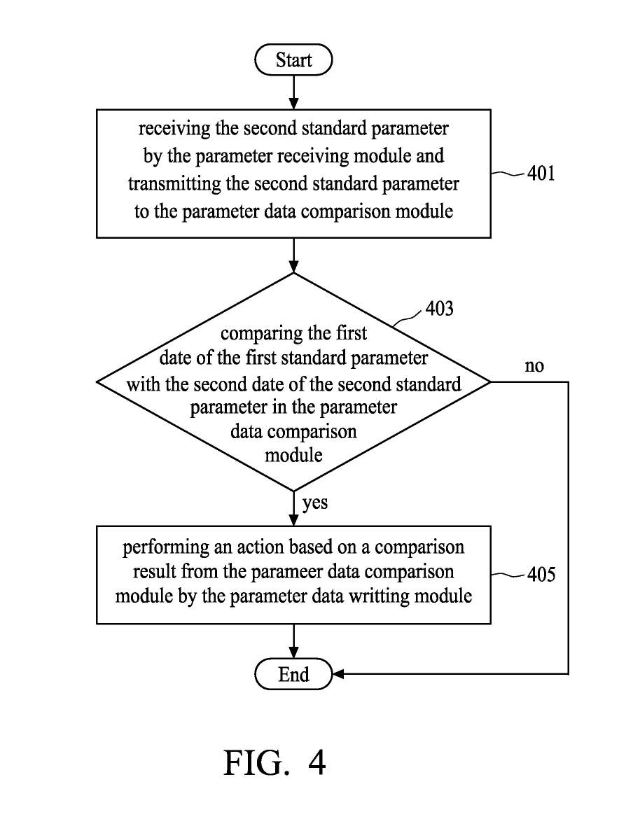

FIG. 4 shows one embodiment of the present invention with a comparison flow chart. In one embodiment of the present invention, the comparison flow chart includes the following steps: in step S401, the parameter receiving module 23 of the electronic calibration device 15 receives the second standard parameter and transmits it to the parameter data comparison module 25; in step S403, the parameter data comparison module 25 compares the first date of the first standard parameter with the second date of the second standard parameter; and in step S405, the parameter data writing module 29 performs an action based on a comparison result from the parameter data comparison module 25.

In step 403, if the first date is later than the second date, the parameter data comparison module 25 sends a parameter data writing signal to the parameter data writing module 29. The parameter data writing module 29 writes the first standard parameter and the writing date into the memory 21 of the electronic device. Meanwhile, the writing date is stored in the second date and the calibration is successfully completed. If the first date is earlier than or equal to the second date, the parameter data comparison module 25 does nothing which means the electronic calibration device 15 will stop working, the parameter data writing module 29 will do nothing and the calibration is successfully completed.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A calibration system of electronic devices, comprising:
an electronic calibration device; and
an electronic device having a space configured to connect to the electronic calibration device;
wherein the electronic calibration device has a calibration parameter storage module configured to pre-store a first standard parameter of a plurality of calibration items of an electronic device.

2. The calibration system of claim 1, wherein the first standard parameter includes a first date.

3. The calibration system of claim 2, wherein the first date is an expiration date of the first standard parameter.

4. The calibration system of claim 1, wherein the electronic device comprises a second standard parameter having a second date.

5. The calibration system of claim 4, wherein the second date is a written date of the second standard parameter.

6. The calibration system of claim 1, wherein the space includes a parameter data transmitting interface configured to connect the electronic device.

7. The calibration system of claim 1, wherein the plurality of calibration items are selected based on the model of the electronic device.

8. The calibration system of claim 1, wherein the electronic device includes semiconductor equipment.

9. The calibration system of claim 1, wherein the electronic device further comprises a parameter data receiving module, a parameter data comparison module and a parameter data writing module.

10. The calibration system of claim 9, wherein the parameter data receiving module is configured to receive the first standard parameter data of the electronic device.

11. The calibration system of claim 9, wherein the parameter data comparison module is configured to compare the first date and the second date.

12. The calibration system of claim 9, wherein the parameter data writing module is configured to write the first standard parameter data and a written date into the electronic device.
